(19) United States
(12) Patent Application Publication
(10) Pub. No.: US 2012/0224118 A1
(43) Pub. Date: Sep. 6, 2012

(54) LIQUID CRYSTAL DISPLAY DEVICE

(75) Inventors: Yohsuke Kanzaki, Osaka (JP); Yuhichi Saitoh, Osaka (JP)

(73) Assignee: SHARP KABUSHIKI KAISHA, Osaka (JP)

(21) Appl. No.: 13/509,369

(22) PCT Filed: Jun. 18, 2010
(86) PCT No.: PCT/JP2010/004094

§ 371 Date: May 17, 2012

(30) Foreign Application Priority Data
Nov. 12, 2009 (JP) 2009-258983

(51) Int. Cl. G02F 1/1337; G02F 1/1339

(52) U.S. Cl. 349/58

(57) ABSTRACT

On the surface of a first substrate on the side of a liquid crystal layer, an alignment film formed by curing a resin material having fluidity is provided so as to expand from a pixel region to a part of a terminal region through a connection region. At least between mounting terminals and the pixel region, a restriction structure portion for restricting the flow of the resin material that has not cured yet is formed. Each of the plurality of mounting terminals exposed to outside from the alignment film.

### TECHNICAL FIELD

The present invention relates to a liquid crystal display device, and particularly relates to control of a coating region of an alignment film.

### BACKGROUND ART

A liquid crystal display generally has a structure that seals a liquid crystal layer between a pair of substrates. One of the pair of substrates is a TFT substrate upon which are formed a plurality of gate wiring lines, a plurality of source lines, a plurality of pixel electrodes, and a plurality of TFTs or the like. The other substrate of the pair of substrates is an opposite substrate upon which is formed a common electrode that is shared in common by a plurality of pixel electrodes.

On the liquid crystal layer side surfaces of the TFT substrate and opposite substrate are arranged alignment films for controlling the orientation of the liquid crystals in the aforementioned liquid crystal layer. The alignment film is composed of polyimide or like resin film, for example, whose surface undergoes a rubbing treatment.

The alignment film is formed by coating liquid polyimide onto the surface of the TFT substrate and the opposite substrate, followed by baking and curing the coating. The polyimide may be coated by the flexographic printing method, inkjet printing method, or the like, for example.

Here, as shown in the magnified view of the end portion of the TFT substrate shown in FIG. 18, the TFT substrate 101 has a pixel region 103 as a display region in which are formed a plurality of pixel electrodes 102, and a frame region 104 outside thereof as a non-display region. A plurality of wiring lines 105 such as gate wiring lines are formed in the pixel region 103.

On the other hand, the frame region 104 includes a terminal region 107, which is a region in the substrate edge portion and which has a plurality of mounting terminals 106 formed thereon, and a connection region 108 as a region between this terminal region 107 and the pixel region 103.

In the connection region 108 are formed connection wiring lines 109 connecting the mounting terminals 106 and the wiring lines 105, a common transfer electrode 110 as an electrode electrically connected to the common electrode of the opposite substrate, and a sealing member 111 for sealing in the liquid crystal layer. The sealing member 111 is disposed at the outer side of the connection region 108, and the common transfer electrode 110 is disposed so as to overlap the sealing member.

Although the alignment film 112 is formed over the entire pixel region 103, the film thickness of the end portion of this alignment film 112 readily becomes non-uniform. Therefore the end portion of the alignment film 112 is normally formed to the interior of the sealing member at the connection region 108 (e.g. see Patent Document 1 or the like). Due to this configuration, it becomes possible to suppress display irregularities caused by non-uniformity of the film thickness of the alignment film 112.

However, dimensional control and morphological control of the end portion of this type of alignment film are generally difficult. In response to this difficulty, Patent Document 1 mentions coating of an alignment film material by the inkjet method in the connection region and formation of a dot pattern that is rougher than other portions in the outside end part of the alignment film (i.e., the sealing member side end portion). Spreading of the alignment film material to the sealing member side is suppressed by this way.

Moreover, as shown in the magnified end portion views of the TFT substrate shown in FIGS. 19 and 20, the liquid crystal display mentioned in Patent Document 2 has a depression trench 114 extending along the interior side of the sealing member 11a at the connection region 108 of the TFT substrate 101. In this manner, this depression trench 114 is used to attempt to suppress the spreading of the alignment film material from the pixel region 103 toward the sealing member 111 side.

Here, within FIGS. 19 and 20, the reference character 115 indicates the common bus line formed on the glass substrate 118 composing the TFT substrate 101. The common bus line 115 is a wiring line for application of a prescribed voltage to the common electrode of the opposite substrate through the common transfer electrode. Moreover, the depression trench 114 is formed in an insulating film 119 covering the common bus line 115, and the inner face and bottom face of the depression trench 114 is composed of a transparent electrically conductive film 116.

### RELATED ART DOCUMENTS

### Patent Documents

Patent Document 1: Japanese Patent Application Laid-Open Publication No. 2004-361623

Patent Document 2: Japanese Patent Application Laid-Open Publication No. 2007-322627

### SUMMARY OF THE INVENTION

### Problems to be Solved by the Invention

However, in order to reliably place the non-uniform thickness region of the alignment film in the connection region, a connection region of relatively great width must be formed. Thus, there has been a problem in that reduction of width of the frame region is difficult.

The present invention is developed in consideration of this point. A main object of the present invention is to reduce the frame region while reliably placing the region of non-uniform thickness of the alignment film on the outside of the pixel region.

### Means for Solving the Problems

It order to attain the aforementioned object, the present invention is directed to a liquid crystal display device composed of: a first substrate; a second substrate disposed facing the aforementioned first substrate; a liquid crystal layer arranged between the aforementioned first substrate and the aforementioned second substrate; and a sealing member for surrounding and sealing the aforementioned liquid crystal layer arranged between the aforementioned first substrate and the aforementioned second substrate.

Also, the aforementioned first substrate has a pixel region as a display region and a frame region as a non-display region formed outside of the aforementioned pixel region; the aforementioned frame region has a terminal region formed at an end portion of the aforementioned first substrate and has a connection region located between the aforementioned terminal region and the aforementioned pixel region, a plurality of mounting terminals being arranged in the aforementioned frame region, and the aforementioned sealing member being arranged at the aforementioned connection region; an alignment film that is formed by curing of a resin having fluidity at the aforementioned liquid crystal layer side face of the aforementioned first substrate is arranged so as to spread from the aforementioned pixel region through the aforementioned connection region to part of the aforementioned terminal region; a restriction structure portion is formed between at least the aforementioned mounting terminal and the aforementioned pixel region to restrict flow of the aforementioned resin material prior to curing; and each terminal of the aforementioned plurality of mounting terminals is exposed from the aforementioned alignment film.

In the present invention, when the alignment film is formed on the first substrate, the uncured resin material for forming the alignment film is supplied on the pixel region and this resin material flows from the pixel region to the terminal region through the connection region. Although a plurality of mounting terminals are arranged in the terminal region, due to the formation of the restriction structure portion between these mounting terminals and the pixel region, flow of the resin material toward the aforementioned mounting terminal can be restricted such that, due to the restriction structure portion, the flow of the resin material avoids the mounting terminal. Thus, a plurality of mounting terminals can be exposed from the alignment film.

Due to this ability, while disposing the region of non-uniform film thickness of the alignment film reliably in the terminal region outside of the pixel region, it becomes possible to reduce the size of the frame region because there is no need to form a wide connection region.

### Effects of the Invention

According to the present invention, while disposing the region of non-uniform film thickness of the alignment film reliably in the terminal region outside of the pixel region, it becomes possible to reduce the size of the frame region because there is no need to form a wide connection region.

### BRIEF DESCRIPTION OF THE DRAWINGS

FIG. 1 is a plan view showing a TFT substrate upon which is formed an alignment film according to Embodiment 1 of the present invention.

FIG. 2 is a magnified plan view showing the vicinity of a plurality of mounting terminals.

FIG. 3 is a magnified plan view showing the vicinity of the common transfer electrode.

FIG. 4 is a plan view showing the liquid crystal display according to Embodiment 1.

FIG. 5 is a magnified cross-sectional drawing showing structure of the liquid crystal display of Embodiment 1.

FIG. 6 is a magnified plan view showing schematically the end portion of the TFT substrate.

FIG. 7 is a plan view showing resin material after arrival of flow of the resin material at the third trench portion.

FIG. 8 is a cross-sectional view along the line XIII-XIII in FIG. 7.

FIG. 9 is a cross-sectional view along the line IX-IX in FIG. 7.

FIG. 10 is a plan view showing a resin material after arrival of flow of the resin material at the downstream end of the third trench portion.

FIG. 11 is a cross-sectional view along the line XI-XI in FIG. 10.

FIG. 12 is a cross-sectional view along the line XII-XII in FIG. 10.

FIG. 13 is a plan view showing schematically the restriction structure portion according to Embodiment 2 of the present invention.

FIG. 14 is a plan view showing schematically the restriction structure portion according to Embodiment 3 of the present invention.

FIG. 15 is a plan view showing schematically the restriction structure portion according to Embodiment 4 of the present invention.

FIG. 16 is a plan view showing schematically the restriction structure portion according to Embodiment 5 of the present invention.

FIG. 17 is a plan view showing schematically the restriction structure portion of this Embodiment 6.

FIG. 18 is a magnified plan view showing schematically the end portion of the conventional TFT substrate.

FIG. 19 is a magnified plan view showing schematically the end portion of the conventional TFT substrate.

FIG. 20 is a magnified cross-sectional view along the XX-XX cross section of FIG. 19.

### DETAILED DESCRIPTION OF EMBODIMENTS

Embodiments of the present invention will be described below in detail based on the drawings. The present invention is not limited to the below described embodiments.

### Embodiment 1 of the Present Invention

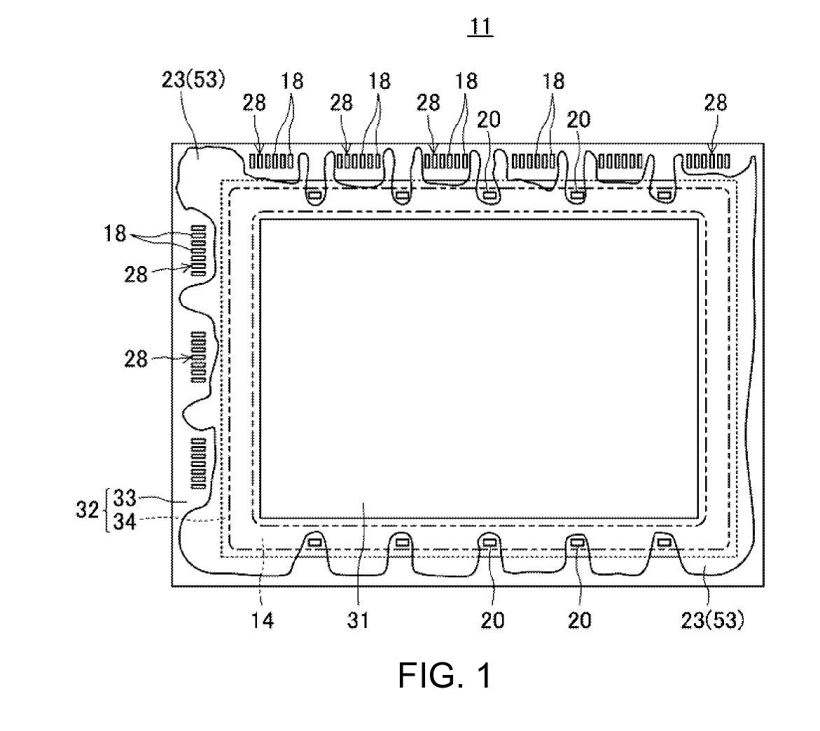

The Embodiment 1 of the present invention is shown in FIGS. 1 to 12.

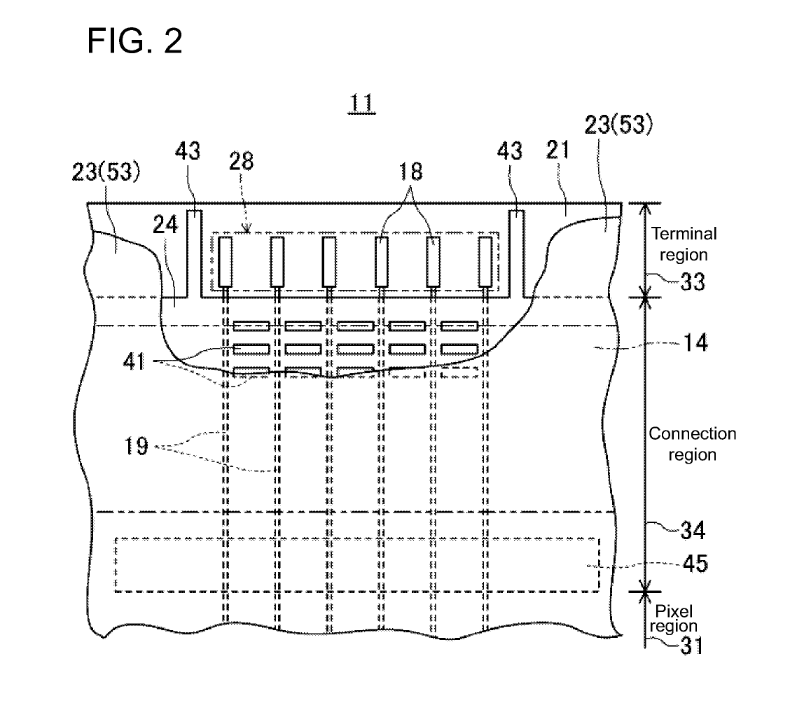

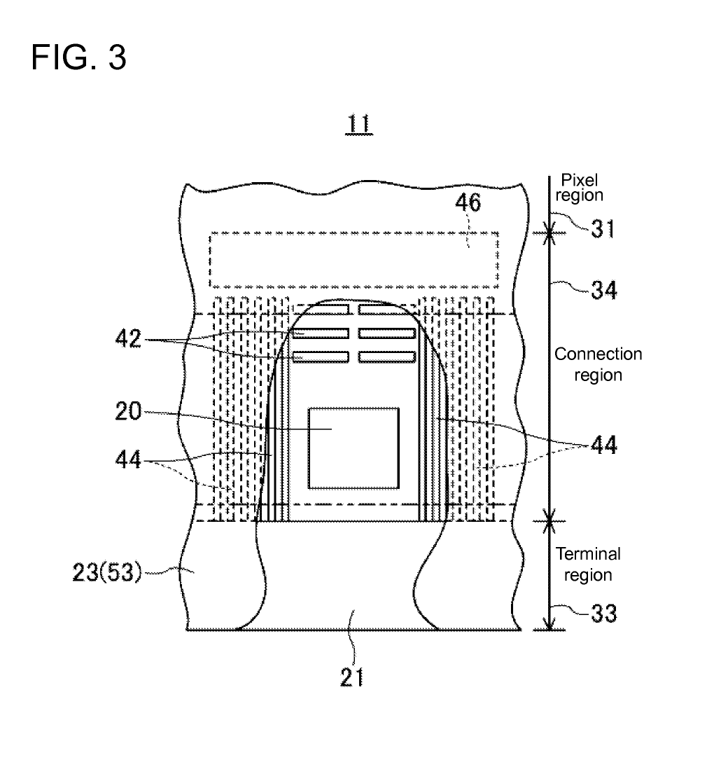

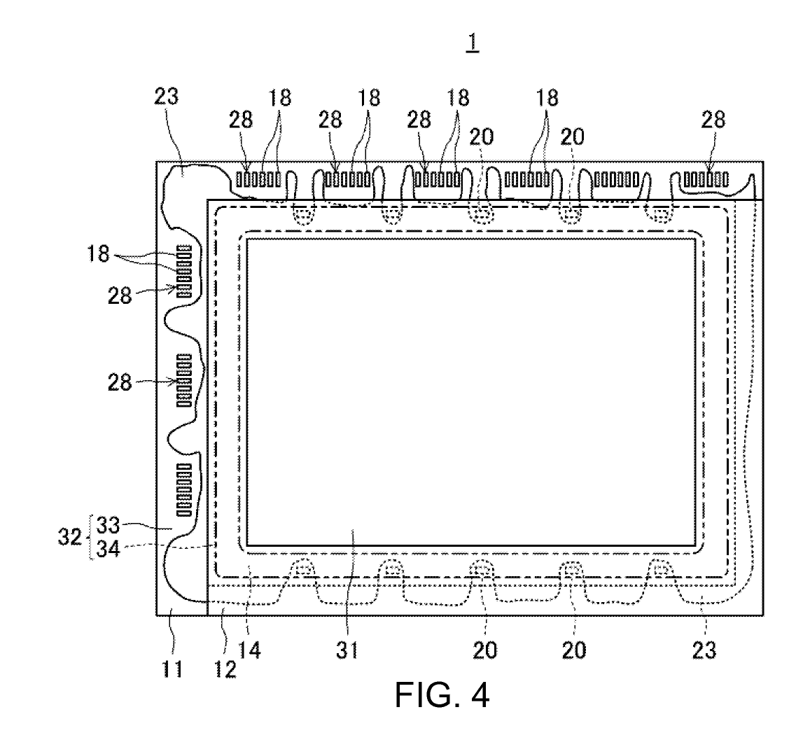

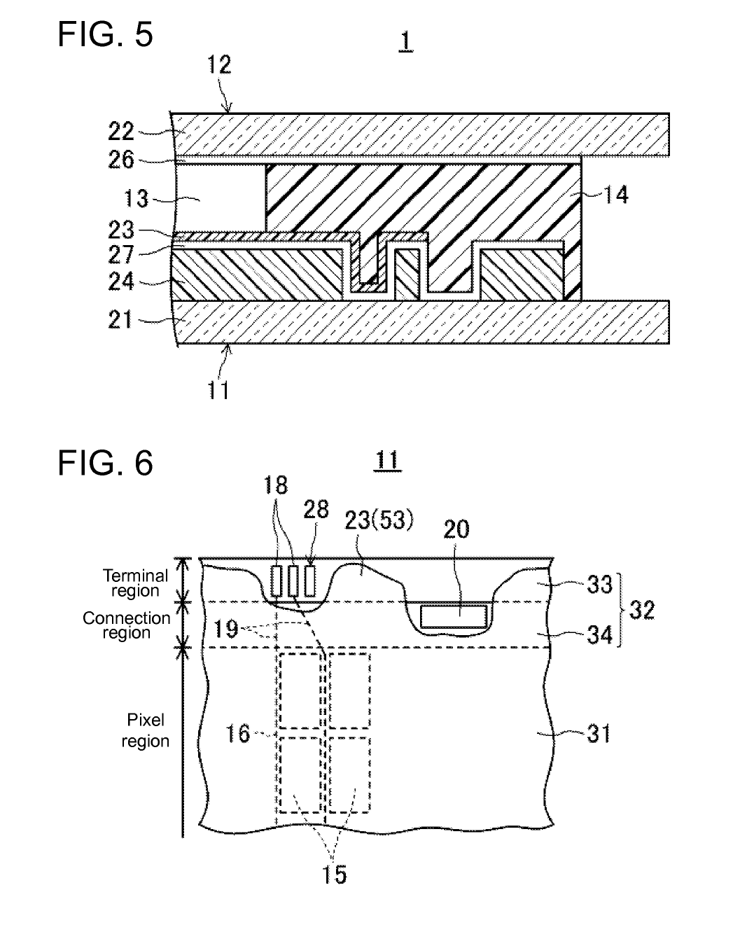

FIG. 1 is a plan view showing a TFT substrate 11 upon which is formed the alignment film 23 according to Embodiment 1 of the present invention. FIG. 2 is a magnified plan view showing the vicinity of the plurality of mounting terminals 18. FIG. 3 is a magnified plan view showing the vicinity of the common transfer electrode 20. FIG. 4 is a plan view showing the liquid crystal display 1 of this Embodiment 1. FIG. 5 is a magnified cross-sectional drawing showing the structure of the liquid crystal display 1 of Embodiment 1. FIG. 6 is a magnified plan view showing schematically the end portion of the TFT substrate 11.

As shown in FIGS. 4 and 5, the liquid crystal display 1 has a TFT substrate 11 as the first substrate, an opposite substrate 12 as the second substrate disposed facing the TFT substrate 11, and a liquid crystal layer 13 arranged between the TFT substrate 11 and the opposite substrate 12.

Moreover, the liquid crystal display 1 has a sealing member 14, provided between the TFT substrate 11 and the opposite substrate 12, for surrounding and sealing the liquid crystal layer 13. As shown in FIG. 4, the sealing member 14 is formed in a roughly rectangular frame shape, and the sealing member 14 is made of a ultraviolet-thermal dual curable resin such as an epoxy based resin, for example.

As shown in FIG. 5, the opposite substrate 12 has a glass substrate 22 that is a transparent plate. On the liquid crystal layer 13 side of this glass substrate 22 are formed a color filter (not shown), a common electrode 26 formed of ITO or the like, and an alignment film covering these components.

As shown in FIG. 1, the TFT substrate 11 has a pixel region 31 that has a display region and has a frame region 32 as a non-display region formed on the outer periphery of this pixel region. A plurality of pixels (not shown) are disposed in a matrix pattern in the pixel region 31.

As shown in FIG. 6, a respective pixel electrode 15 made of ITO or the like is formed for each pixel. Moreover, for each pixel, a thin film transistor (TFT, not shown) is formed as a switching element connected to the pixel electrode 15. Furthermore, a plurality of the wiring lines 16 are formed so as to be are connected to the aforementioned TFT on the TFT substrate 11. Gate wiring lines and source wiring lines or the like are included in a plurality of wiring lines 16.

Moreover, the TFT substrate 11 has a glass substrate 21, which is a transparent substrate, and an insulating film 24 for covering the aforementioned TFTs (not shown), and wiring lines 16 or the like are formed on the liquid crystal layer 13 side of this glass substrate 21. The aforementioned pixel electrode 15 is formed on the surface of the insulating film 24. Moreover, an ITO film 27 is also formed on the surface of the insulating film 24 in the frame region 32.

On the other hand, as shown in FIGS. 1 and 6, the frame region 32 is a region formed at the end portion of the TFT substrate 11, and the frame region 32 has a terminal region 33 provided with a plurality of the mounting terminals 18 and a connection region 34 as a region located between this terminal region 33 and the pixel region 31.

In the connection region 34 are provided a plurality of the connection wiring lines 19 for connecting the mounting terminals 18 to the wiring lines 16, a plurality of the common transfer electrodes 20 as electrode parts, and the aforementioned sealing member 14. As shown in FIG. 1, the connection region 34 is formed so as to surround the entire periphery of the rectangular-shaped pixel region 31.

As shown in FIG. 1, the sealing member 14 is disposed at the center along the width direction of the connection region 34. On the other hand, the respective common transfer electrodes 20 are disposed at a prescribed interval along two opposite sides of the TFT substrate 11, and are overlapped by the sealing member 14. Moreover, within the region where the sealing member 14 is formed, each respective common transfer electrode 20 is disposed off-centered with respect to the side of the pixel region 31. The common transfer electrode 20 is connected electrically to the common electrode 26 of the opposite substrate 12 via conductive particles (not shown), a conductive paste (not shown) or the like included in the sealing member 14 so as to apply a prescribed voltage to the common electrode 26.

As shown in FIG. 1, the terminal region 33 is a rectangular frame shaped region formed at the outer sides of the connection region 34, and terminal groups 28 composed of a plurality of mounting terminals 18 are disposed at two adjacent sides of the TFT substrate 11 with prescribed gaps between terminal groups 28.

On the surface side of the liquid crystal layer 13 of the TFT substrate 11, the alignment film 23 formed by curing a resin material 53 having fluidity is formed so as to cover the aforementioned pixel electrode 15 and the ITO film 27. As shown in FIG. 1, the alignment film 23 is disposed so as to spread from the pixel region 31 to part of the terminal region 33 through the connection region 34. The aforementioned common transfer electrodes 20 and a plurality of mounting terminals 18 are each exposed from the alignment film 23. Polyimide or like resin, for example, can be used for the resin material 53 composing the alignment film 23.

As shown in FIG. 2, a first trench portion 41, as a restriction structure portion, is formed for restriction of flow of the pre-cured resin material 53 at least between the pixel region 31 and the mounting terminal 18.

The first trench portions 41 are composed of trench portions formed in the insulating film 24 on the TFT substrate 11, and are multiply arranged from the mounting terminal 18 side to the pixel region 31 side between adjacent connection wiring lines 19 at a prescribed interval. Each first trench portion 41 has a shape that extends laterally along the direction of the side of the TFT substrate 11.

Part of the alignment film 23 is disposed within the inside of at least one of a plurality of the first trench portions 41. The other first trench portions 41 as well as the mounting terminals 18 are not covered by the alignment film 23 and are exposed. Furthermore, as shown in FIGS. 2 and 5, at least parts of the first trench portions 41 are placed so as to overlap the sealing member 14. The contact area between the sealing member 14 and the TFT substrate 11 is increased in this manner.

Moreover, a first depression portion 45 is formed in the insulating film 24 between the first trench portion 41 and the pixel region 31. The first depression portion 45 retains pre-cured resin material 53. The first depression portion 45 has a shape that extends laterally along the direction of the side of the TFT substrate 11. As shown in FIG. 2, the lateral direction width of this first depression portion 45 is greater than the lateral direction width of the terminal group 28. Also, the first depression portion 45 is entirely covered by the alignment film 23.

Furthermore, in the terminal region 33, the terminal group 28 extends along the periphery of the TFT substrate 11 at the mounting terminals 18, and a dike portion 43 is formed as a restriction structure portion at either lateral-direction side of the terminal group 28. The dike portion 43 is made of the same material as the insulating film 24, and is formed in an integrated manner with the insulating film 24. The dike portions 43 prevent intrusion of the resin material 53 into the terminal group 28 in the lateral direction.

As shown in FIG. 3, a second trench portion 42 as a restriction structure portion is formed at least between the common transfer electrode 20 and the pixel region 31.

The second trench portion 42 is composed of trench portions formed in the insulating film 24, and these are lined up in a plurality of columns with a prescribed gap therebetween from the mounting terminal 18 side toward the pixel region 31 side. Each second trench portion 42 has a shape that extends laterally along the periphery of the TFT substrate 11.

Part of the alignment film 23 is provided in the inside of at least one of the plurality of first trench portions 41. The other first trench portions 41 as well as the mounting terminal 18 are not covered by the alignment film 23 and are exposed.

Furthermore, in the connection region 34, on both sides of the common transfer electrode 20 and the second trench portions 42—the sides being with respect to the direction in which the side of the TFT substrate 11 extends, a plurality of third trench portions 44 are formed as restriction structure portions. The third trench portions 44 are formed in the insulating film 24 in the same manner as the second trench portions 42. Moreover, each third trench portion 44 has a shape extending in a direction intersecting the side of the TFT substrate 11 (particularly preferably in the direction perpendicular to the side of the TFT substrate 11).

Moreover, a second depression portion 46 is formed in the insulating film 24 between the second trench portion 42 and the pixel region 31. The second depression portion 46 retains pre-cured resin material 53. The second depression portion 46 has a shape that extends laterally along the direction of the side of the TFT substrate 11. As shown in FIG. 3, the lateral direction width of this second depression portion 46 is greater than the lateral direction width of the common transfer electrode 20. Also, the second depression portion 46 is entirely covered by the alignment film 23.

With the structure described above, as shown in FIG. 1, the alignment film 23 is formed such that its peripheral edge has a curved shape having depressions and protrusions as viewed from a direction normal to the TFT substrate 11, and at least part of the peripheral edge of this alignment film 23 is disposed in the terminal region 33.

### Manufacturing Method

A method of manufacturing the aforementioned liquid crystal display 1 will be explained next.

The liquid crystal display 1 is manufactured by forming the frame-shaped sealing member 14 on the TFT substrate 11 or the opposite substrate 12, then dropping the liquid crystal inside this sealing member 14, and by gluing the resultant TFT substrate 11 and the opposite substrate 12 together.

In the present embodiment, a manufacturing process is explained for a TFT substrate 11 having features of the present invention. First, TFTs (not shown) and a plurality of wiring lines 16 or the like are formed on a surface of the glass substrate 21, which is a transparent substrate. Next, an insulating film 24 is formed to cover the aforementioned TFTs and the wiring lines 16.

The insulating film 24 may be formed using a photosensitive organic material or a non-photosensitive insulating film. If a photosensitive organic material is used, the organic material may be formed as a uniformly thick film on the glass substrate by the spin coat method, for example, although it is also possible to use the spray coat method or inkjet method. The thickness of the film of organic material is 2 to 3 μm, for example. Thereafter, photolithography and etching are used to form the aforementioned restriction structure portions, i.e., the first trench portion 41, second trench portion 42, dike portion 43, third trench portion 44, first depression portion 45, and second depression portion 46.

If a non-photosensitive insulating film is used to form the insulating film 24, then the CVD method (sputtering method or application of a coating type material may also be used) is used, for example, to form a uniformly thick layer of insulating material on the glass substrate 21. Thereafter, a photosensitive resist is coated onto the entire surface of this insulating material layer. Next, a prescribed resist pattern is formed by the photolithography method. Thereafter, the insulating material layer is etched (wet etching or dry etching) and the resist pattern is removed to form the aforementioned restriction structure portions, i.e., the first trench portions 41 and the like.

Thereafter, by forming an ITO layer on the surface of the aforementioned insulating film 24, the plurality of pixel electrodes 15 and the ITO film 27 are formed by photolithography and etching of the ITO layer.

Thereafter, a resin material 53 that has fluidity (i.e., polyimide or the like) is provided so as to cover the aforementioned pixel electrode 15 and the other components. The resin material 53 flows from the pixel region 31 toward the terminal region 33 through the connection region 34. Accordingly, the flow of the resin material 53 is restricted by the restriction structure portions, i.e., the aforementioned first trench portions 41 and the other structures. Thus, the resin material 53 is guided by the aforementioned first trench portions 41 and other structures to flow along respective trenches.

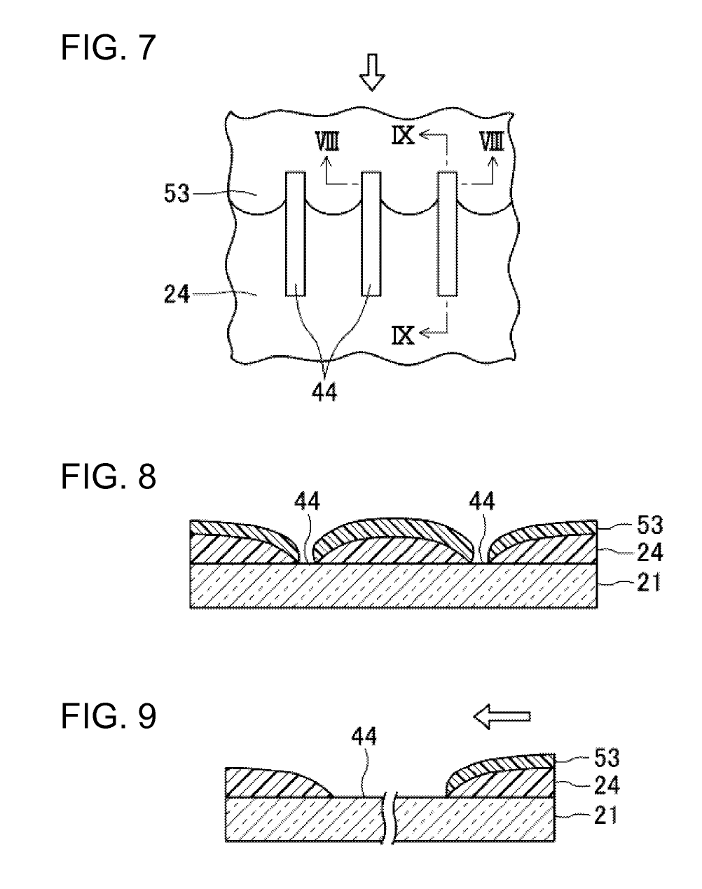

Referring to FIGS. 7 to 12, the behavior of the resin material flowing through a region in which a plurality of third trench portions 44 extending parallel to each other are formed will be explained.

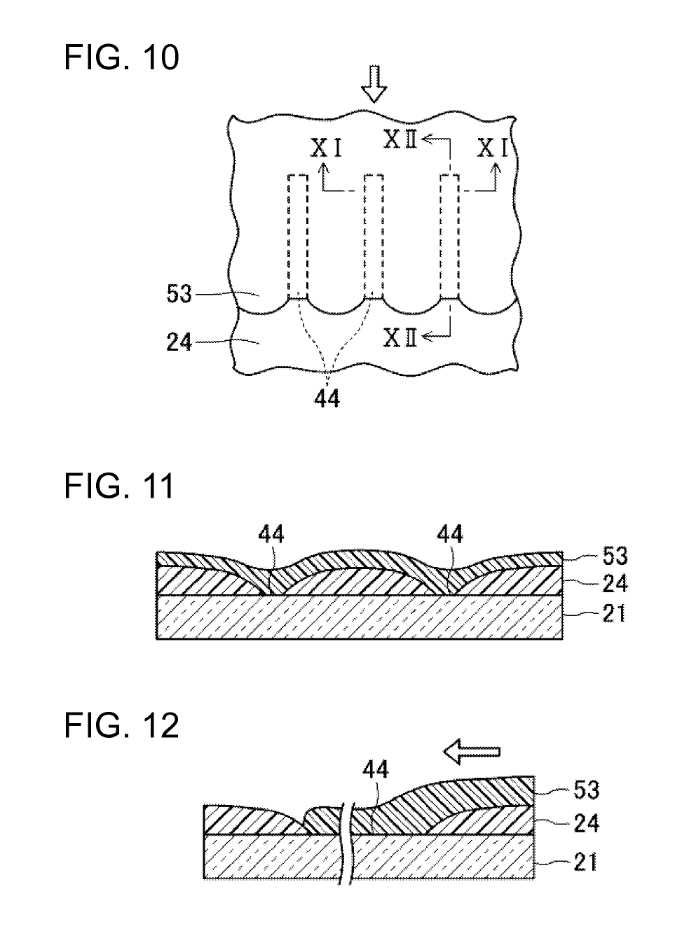

FIG. 7 is a plan view showing the resin material when the flow of the resin material reaches the third trench portions 44. FIG. 8 is a cross-sectional view along the line XIII-XIII in FIG. 7. FIG. 9 is a cross-sectional view along the line IX-IX in FIG. 7. FIG. 10 is a plan view showing the resin material the flow of the resin material reaches the downstream end of the third trench portions 44. FIG. 11 is a cross-sectional view along the line XI-XI in FIG. 10. FIG. 12 is a cross-sectional view along the line XII-XII in FIG. 10.

As shown in FIGS. 7 and 10, the resin material 53 flows along the trench lengthwise direction of the third trench portion 44. As shown in FIGS. 7 and 9, because the third trench portions 44 themselves provide resistance to the flow, the resin material 53 that has reached the upstream end part in the third trench portion 44 starts to flow ahead between the respective third trench portions 44. At this time, as shown in FIG. 8, due to the surface tension of the resin material 53, the resin material remains on the surface of the insulating film 24 and does not flow into the interiors of the third trench portions 44.

Thereafter, due to downstream flow of the resin material 53, this resin material 53 starts to flow even into the interior of the third trench portions 44. Then, as shown in FIG. 10, when the resin material 53 reaches the downstream end of the third trench portions 44, the resin material 53 between respective third trench portions 44 flows out first, and then the resin material 53 that has flowed into the interiors of the third trench portions 44 flows out from the third trench portions 44 with a delay. In this manner, the trench portions act as resistance to the flow of the resin material 53, and the trench portions guide the flow of resin material 53 in the lengthwise direction of the trenches.

In this manner, the resin material 53 flows from the pixel region 31 to the terminal region 33, and the flow is restricted by the first trench portion 41, second trench portion 42, third trench portion 44, and the other like structures so that the resin material avoids the terminal group 28 and the common transfer electrode 20.

### Effect of Embodiment 1

As described above, when the pre-cured resin material 53 for forming the alignment film 23 is supplied to the pixel region 31, the resin material 53 flows from the pixel region 31 to the terminal region 33 through the connection region 34. Although a plurality of mounting terminals 18 are arranged in the terminal region 33, according to this Embodiment 1, because the restriction structure portions (first trench portions 41) are formed between these mounting terminals 18 and the pixel region 31, the flow of the resin material toward these mounting terminals 18 can be restricted so as to avoid the mounting terminals 18 by the first trench portions 41. Thus, it is possible to cause the plurality of mounting terminals 18 to be exposed from the alignment film 23.

Accordingly, there is no need to form a wide connection region 34 in ensuring that the edge region of the alignment film 23, which has a non-uniform film thickness, be located 31 in the terminal region 33 outside of the pixel region, and therefore, it is possible to reduce size of the frame region 32 due to.

Furthermore, due to formation of the restriction structure portions between the common transfer electrode 20 and the pixel region 31 (second trench portions 42), the edge part of the alignment film 23 can be formed in the terminal region 33 while exposing common transfer electrode 20 from the alignment film 23.

Further, because the restriction structure portions are constituted of a plurality of trench portions 41, 42, and 44, the restriction structure portions can be formed on the TFT substrate 11 with ease.

Furthermore, because the sealing member 14 overlaps the restriction structure portions (first trench portion 41, second trench portion 42, and third trench portion 44), the contact area between the sealing member 14 and the TFT substrate 11 is increased at these restriction structure portions (first trench portion 41, second trench portion 42, and third trench portion 44). As a result, it is possible to enhance the bonding strength between this sealing member 14 and the TFT substrate 11.

Further, because the restriction structure portions (dike portion 43 and third trench portion 44) are disposed along the direction of the side of the TFT substrate 11 where the mounting terminal 18 or the common transfer electrode 20 are located, the resin material 53 that has avoided the mounting terminal 18 or the common transfer electrode 20 by flowing laterally may be prevented from again approaching this mounting terminal 18 or common transfer electrode 20. In this manner, it is possible to more reliably expose the mounting terminal 18 or common transfer electrode 20 from the alignment film 23.

Furthermore, because the restriction structure portions (first trench portion 41 and second trench portion 42) between the mounting terminal 18 and the pixel region 31 are formed of a shape that extends laterally along the direction of the side of the TFT substrate 11, it is possible to suitably restrict the flow of the resin material 53.

Moreover, because the periphery edge of the alignment film 23 has a shape of protrusions and depressions, it becomes possible to dispose the alignment film 23 in the terminal region 33 with high efficiency.

Furthermore, because the first depression portion 45 and the second depression portion 46 are respectively disposed between the pixel region 31 and the restriction structure portions (first trench portions 41 and second trench portions 42), the resin material that has begun to flow from the pixel region 31 side is retained by these depression portions 45 and 46, and it becomes possible to prevent excess flow of the resin material 53 in the direction of the plurality of mounting terminals 18.

Furthermore, because the common transfer electrode 20 is placed off-centered relative to the pixel region 31 within the region in which the sealing member 14 is formed, it becomes possible to form the connection region 34 with sufficiently narrow width while securing a sufficient space for placement of the restriction structure portions (second trench portions 42) on the pixel region 31 side of the common transfer electrode 20.

### Embodiment 2 of the Present Invention

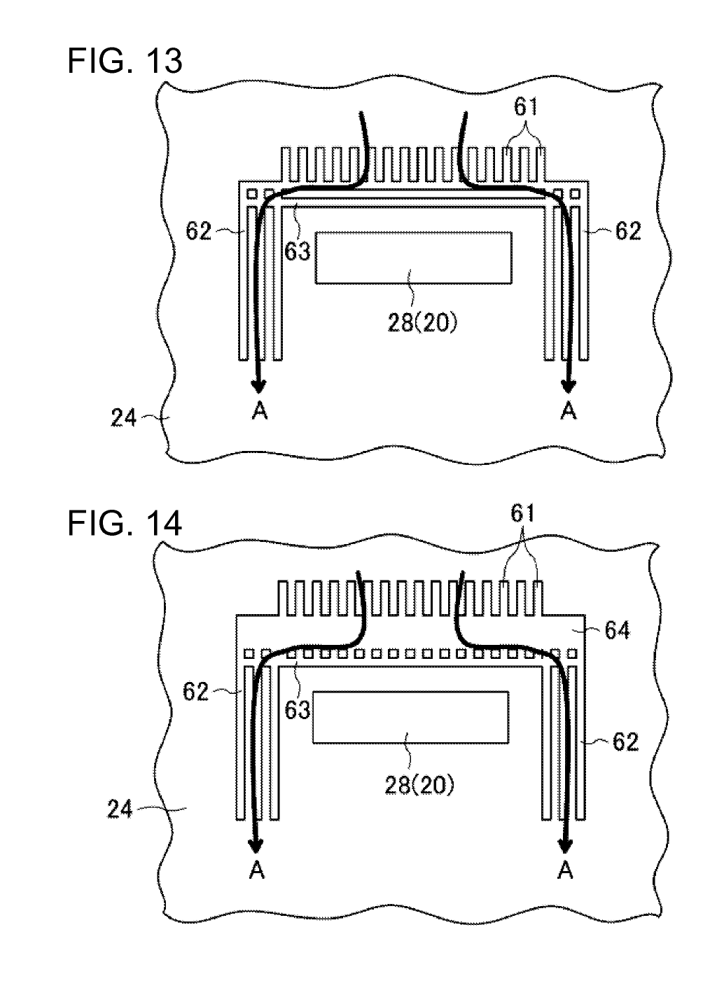

FIG. 13 shows Embodiment 2 of the present invention.

FIG. 13 is a plan view showing schematically a restriction structure portion of Embodiment 2 of the present invention. Moreover, within the various embodiments mentioned below, parts that are identical to those in FIGS. 1 to 12 are assigned the same reference numerals, and a detailed explanation of such parts will be omitted. Moreover, the up-down direction in FIGS. 13 to 17 for each of the below listed embodiments is referred to as the vertical direction, and the right-left direction is referred to as the lateral direction.

The terminal group 28 or common transfer electrode 20 on the glass substrate 21 of the present embodiment 2 are disposed so as to be exposed from the insulating film 24.

On the pixel region 31 side of the terminal group 28 or the common transfer electrode 20, a plurality of fourth trench portions 61, extending in the vertical direction so as to facilitate entry of the resin material 53, are formed in the insulating film 24. On one side of the fourth trench portions 61 facing the terminal group 28 or the common transfer electrode 20, a plurality of fifth trench portions 63 extending in the lateral direction are formed in the insulating film 24. The fifth trench portion 63s are connected to the aforementioned fourth trench portions 61.

Furthermore, a plurality of sixth trench portions 62 extending in the vertical direction are formed in the insulating film 24 on both lateral direction sides of the terminal group 28 or the common transfer electrode 20. The sixth trench portions 62 are connected to the aforementioned fifth trench portions.

The aforementioned fourth to sixth trench portions 61, 62, and 63 may be formed in the same manner as the aforementioned first trench portion 41 of Embodiment 1.

Thus, the present embodiment 2 restricts flow of the resin material 53 by the aforementioned fourth to sixth trench portions 61, 62, and 63, and as shown by the arrows A in FIG. 13, the resin material 53 is guided so as to avoid the terminal group 28 or the common transfer electrode 20. It is thus possible to obtain effects similar to those of the aforementioned Embodiment 1.

### Embodiment 3 of the Present Invention

FIG. 14 shows the Embodiment 3 of the present invention.

FIG. 14 is a plan view showing schematically the restriction structure portion of this Embodiment 3.

In this Embodiment 3, a third depression portion 64 is provided in insulating film 24 in addition to the structure of the aforementioned Embodiment 2. The third depression portion 64 is placed between the fourth trench portion 61 and the fifth trench portion 63, and is formed to extend in the lateral direction. The third depression portion 64 retains the resin material 53 that comes flowing from the pixel region 31 side.

Thus, according to this Embodiment 3, it is possible to suppress excessive flow of the resin material 53 toward the terminal group 28 or the common transfer electrode 20 side. Therefore, it is possible to reliably expose the terminal group 28 or the common transfer electrode 20 from the alignment film 23.

### Embodiment 4 of the Invention

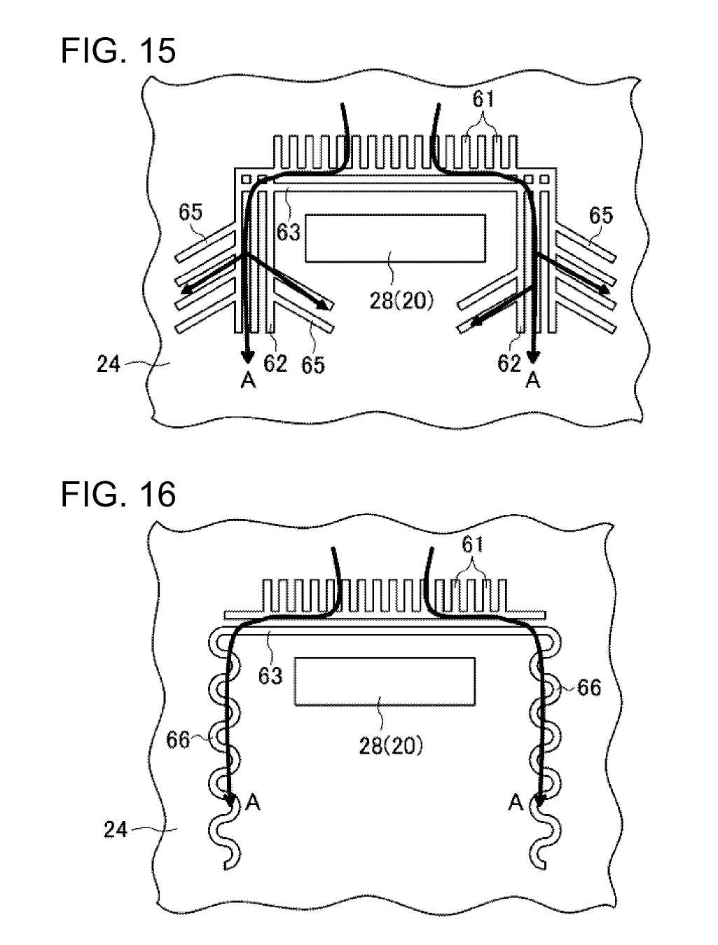

FIG. 15 shows Embodiment 4 of the present invention.

FIG. 15 is a plan view showing schematically the restriction structure portion of this Embodiment 4.

This Embodiment 4 forms seventh trench portions 65 in the aforementioned Embodiment 2 in the insulating film 24. The seventh trench portions 65 are provided at both lateral direction sides of the sixth trench portions 62, and one end of the seventh trench portion 65 is connected to the sixth trench portion 62 while the other end is formed to extend at a tilted angle toward the downstream flow side. As indicated by the arrows shown in FIG. 15, the resin material flowing through the sixth trench portions 62 is guided by the seventh trench portions 65 so as to flow in both lateral direction sides at the downstream side of the sixth trench portions 62.

Therefore, according to the present embodiment 4, because the alignment film 23 can be formed also at an unused space downstream of the terminal group 28 or the common transfer electrode 20, it becomes possible to further reduce the size of the connection region 34.

### Embodiment 5 of the Invention

FIG. 16 shows Embodiment 5 of the present invention.

FIG. 16 is a plan view showing schematically the restriction structure portion of this embodiment 5.

This embodiment 5 forms eighth trench portions 66 in place of the sixth trench portions 62 of the aforementioned Embodiment 2. The eighth trench portion 66 is connected at one end to the fifth trench portion 63 and is formed so as to extend in a snaking manner in the downstream direction. The eighth trench portion 66 guides the resin material 53 so that it flows in a snaking manner.

Thus, the route of flow of the resin material 53 according to this embodiment 5 snakes along the eighth trench portion 66, and it is therefore possible to retain a larger volume of the resin material 53 within each trench portion 66. Moreover, it is possible to suppress downstream flow of the resin material 53 toward the substrate terminal portion.

### Embodiment 6 of the Invention

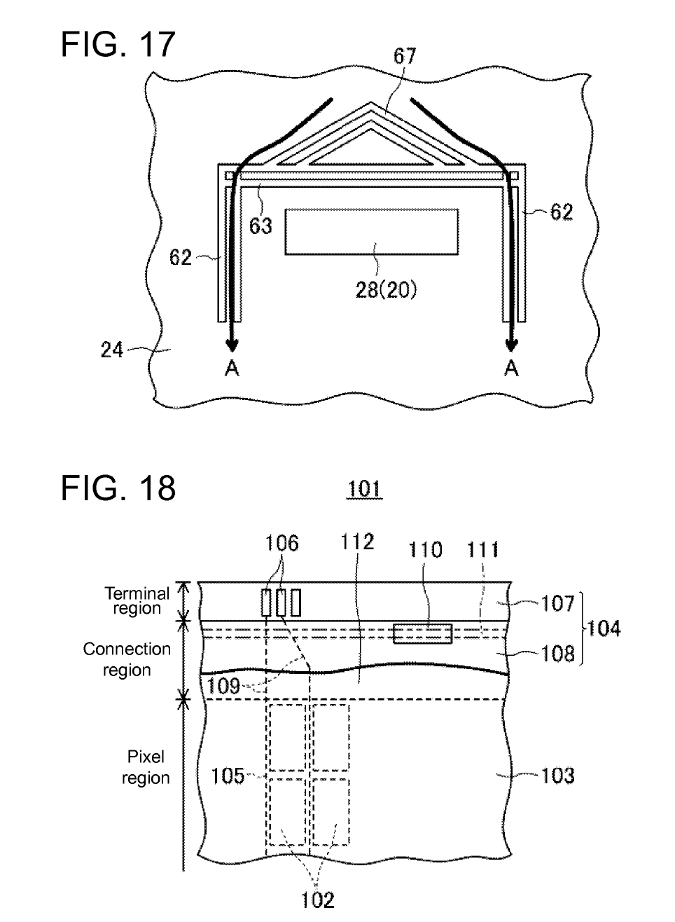

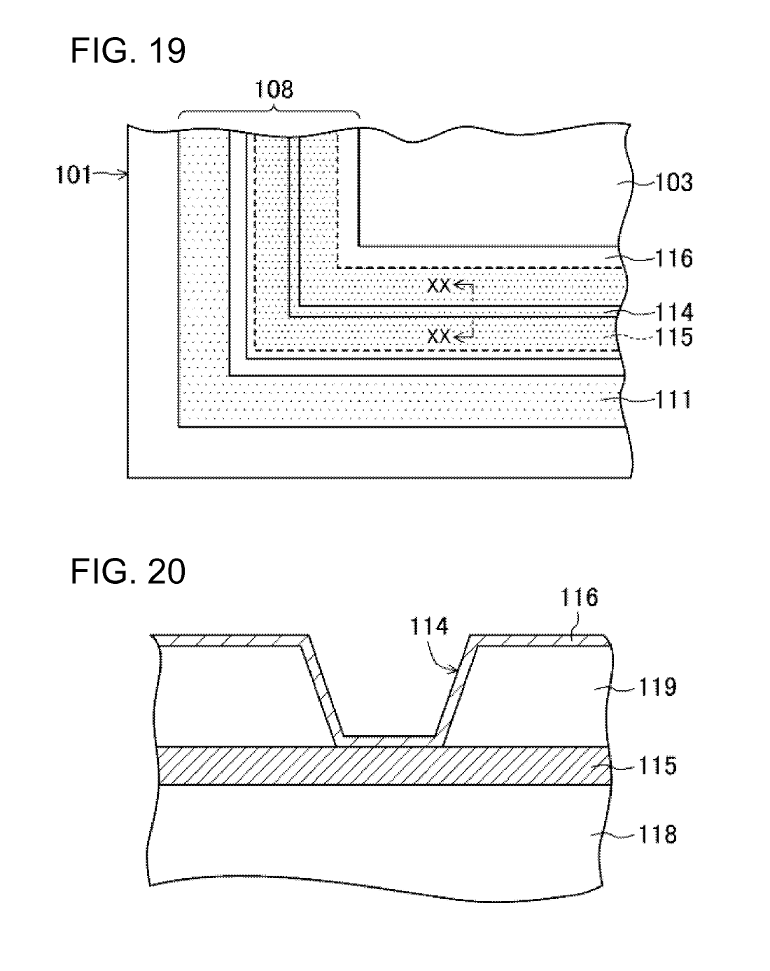

FIG. 17 shows Embodiment 6 of the present invention.

FIG. 17 is a plan view showing schematically the restriction structure portion of this Embodiment 5.

This Embodiment 6 forms a ninth trench portion 67 in place of the fourth trench portions 61 of the aforementioned Embodiment 2. That is to say, the ninth trench portion 67 is provided at the upstream side of the fifth trench portion 63 extending in the lateral direction, and the ninth trench portion 67 is formed so as to extend spreading outwardly at an angle toward the downstream side. Also, the downstream side of the ninth trench portion 67 is connected to the fifth trench portion 63.

Therefore, according to this Embodiment 6, the resin material 53 that flows and arrives at the ninth trench portion 67 is guided so as to spread laterally, and it is thus possible to more reliably expose the terminal group 28 or the common transfer electrode 20 from the alignment film 23.

### Other Embodiments

In the various aforementioned embodiments, the common transfer electrode 20 is overlapped by the sealing member 14. However, the present invention is not limited to this configuration, and the common transfer electrode 20 may be placed to the outside (e.g. terminal region 33 or the like) of the formation region of the sealing member 14.

Moreover, according to the various aforementioned embodiments, the first through ninth trench portions 41, 42, 44, 61-63, and 65-67 were explained as examples of restriction structure portions. However, protrusion-shape structural members may be provided as the restriction structure portions rather than such depressions structural members.

### INDUSTRIAL APPLICABILITY

As explained above, the present invention is useful for a liquid crystal display.

### DESCRIPTION OF REFERENCE CHARACTERS

1 liquid crystal display

11 TFT substrate (first substrate)

12 opposite substrate (second substrate)

13 liquid crystal layer

14 sealing member

18 mounting terminal

20 common transfer electrode (electrode part)

23 alignment film

28 terminal group

31 pixel region

32 frame region

33 terminal region

34 connection region

41 first trench portion (restriction structure portion)

42 second trench portion (restriction structure portion)

43 dike portion (restriction structure portion)

44 third trench portion (restriction structure portion)

45 first depression portion

46 second depression portion

53 resin material

61 fourth trench portion (restriction structure portion)

62 sixth trench portion (restriction structure portion)

63 fifth trench portion (restriction structure portion)

64 third depression portion (restriction structure portion)

65 seventh trench portion (restriction structure portion)

66 eighth trench portion (restriction structure portion)

67 ninth trench portion (restriction structure portion)

1. A liquid crystal display device comprising:
a first substrate;
a second substrate disposed facing said first substrate;
a liquid crystal layer disposed between said first substrate and said second substrate; and
a sealing member for surrounding and sealing said liquid crystal layer disposed between said first substrate and said second substrate,
wherein said first substrate has a pixel region as a display region and has a frame region as a non-display region formed outside of the said pixel region,
wherein said frame region has a terminal region formed at an end portion of said first substrate and has a connection region located between said terminal region and said pixel region, a plurality of mounting terminals is disposed in said frame region, and said sealing member is disposed at said connection region,
wherein an alignment film is disposed on a surface of said first substrate that faces said liquid crystal layer so as to cover said pixel region and a part of said terminal region through said connection region,
wherein a step structure portion is formed at least between said mounting terminals and said pixel region, and
wherein each terminal of said plurality of mounting terminals is exposed from said alignment film.

2. The liquid crystal display according to claim 1,
wherein an electrode part is formed in said connection region,
wherein said step structure portion is formed at least between said electrode part and said pixel region, and
wherein and said electrode part is exposed from said alignment film.

3. The liquid crystal display according to claim 1,
wherein said step structure portion comprises a plurality of trench portions formed on said first substrate, and
wherein a part of said alignment film is disposed in an insider of at least one trench portion of said plurality of trench portions.

4. The liquid crystal display according to claim 1,
wherein at least a part of said step structure portion is disposed so as to overlap said sealing member.

5. The liquid crystal display according to claim 1;
wherein said step structure portion is additionally disposed in a direction of a side of said first substrate where said mounting terminals are located.

6. The liquid crystal display according to claim 2;
wherein said step structure portion is additionally disposed in a direction of a side of said first substrate where said electrode part is located.

7. The liquid crystal display according to claim 6;
wherein said step structure portion disposed in the direction of said side of said first substrate where said electrode part is located has a shape that extends in a direction intersecting with said side of said first substrate.

8. The liquid crystal display according to claim 1;
wherein said step structure portion formed between said mounting terminals and said pixel region has a shape extending laterally in direction of a side of said first substrate.

9. The liquid crystal display according to claim 1;
wherein said alignment film has an edge having a curved shape of depressions and protrusions, as viewed from a direction normal to a surface of said first substrate.

10. The liquid crystal display according to claim 1;
wherein a depression portion for retaining said resin material prior to curing is disposed between said pixel region and said step structure portion formed between said mounting terminals and said pixel region.

11. The liquid crystal display according to claim 2;
wherein said electrode part is disposed off-centered with respect to a side of said pixel region in a region in which said sealing member is formed.
